(19) United States
(12) Patent Application Publication
(10) Pub. No.: US 2009/0301838 A1
(43) Pub. Date: Dec. 10, 2009

(54) ACCUMULATING DEVICE AND METHOD FOR ACCUMULATION OF STREAM OF CONVEYED OBJECTS

(75) Inventor: Holger Mueller, Taucha (DE)

Correspondence Address: RANKIN, HILL & CLARK LLP, 38210 Glenn Avenue, WILLOUGHBY, OH, 44094-7808, US

(73) Assignee: FERAG AG, Hinwil (CH)

(21) Appl. No.: 12/481,113

(22) Filed: Jun. 9, 2009

(30) Foreign Application Priority Data
Jun. 9, 2008 (CH) 872/08

(51) Int. Cl. B65G 47/29

(52) U.S. Cl. 198/343.1; 198/617

(57) ABSTRACT

An accumulation device (4) serves for accumulation of a stream of flat objects (2) conveyed in a conveying direction (3) in an accumulation region (22) of the stream. For this purpose it includes a base (12) of constant length, which is pressable by means of a pressing mechanism (5, 7, 8, 9, 13, 14, 15, 16) against the stream, wherein the pressing mechanism (5, 7, 8, 9, 13, 14, 15, 16) is laid out to first press a first end (10) of the base (12) against the stream and then to press the rest of the base (12) against the stream with a tilting movement and thus, by means of the tilting to form an accumulation region (22) being enlarged in the direction opposing the conveying direction (3).

### BACKGROUND OF THE INVENTION

1. Field of the Invention

The invention relates to the field of conveying technology, in particular for flat objects such as printed products. It concerns an accumulating device and a method for accumulating a stream of conveyed flat objects according to the generic term of the corresponding independent claims.

2. Description of Related Art

For conveying flat objects, e.g. printed products such as newspapers and magazines, they are often brought to form a scaled stream. In certain situations it is necessary to stop the forward conveying in a section of the scaled stream for a short time in order to interrupt the scaled stream. This may e.g. be necessary to separate the scaled stream into individual sections which are subsequently processed further individually, e.g. by forming individual stacks or bundles of flat objects. Hereby, the conveying installation is not to be stopped entirely but only the stream of conveyed objects is to be accumulated or retained for a short time in a region of the conveying region. Thus a locally increased density of the flat objects is formed, which are conveyed further after a short time. If the objects are accumulated merely by being retained in a particular accumulating location they may lose their arrangement as a scaled stream. This may cause problems in further processing.

In FR 2 849 007, this problem is solved by widening an accumulating location into an accumulating region. A scaled stream of flat objects is conveyed on a conveying belt. For accumulating of the scaled stream while the conveying belt continues to run, an accumulation belt is rolled onto the scaled stream in the following manner: the accumulation belt is pressed onto the scaled stream from above by a stationary roller and a movable roller, such that the flat objects are decelerated under the accumulation belt. At the beginning of the accumulation process, the two rollers are near to one another, such that only a few of the flat objects are stopped. Then the movable roller is moved against the conveying direction of the scaled stream and, hereby, the accumulation belt is rolled onto the scaled stream. Thus, an increasingly longer section of the scaled stream is retained by the accumulation belt. Due to the movable roller running against the conveying direction of the scaled stream, the point in which the flat objects are accumulated is shifted, such that that the objects do not all accumulate at one single accumulating point. Instead, the scaled stream is compacted along a longer region. The described device is complicated to manufacture and costly in operation.

FR 2 363 505 shows, among others, a beam with a braking element which can be lowered against a scaled stream of objects by means of two separately controllable drives, one at each end of the beam. When braking the scaled stream, the braking element presses, through the scaled stream, against a conveyor belt. As a result, at such a pressing point, the conveyor belt rubs, under pressure, against the products in the scaled stream, and can damage the products.

EP 1 657 200 A1 shows an approach to avoid this rubbing under pressure: The products in the scaled stream are lifted, by means of movable cams, off the conveyor belt. The mechanism is complicated.

### BRIEF SUMMARY OF THE INVENTION

It is, thus, the object of the invention to create an accumulating device and a method for accumulating a stream of conveyed flat objects of the kind initially mentioned, which removes the above named disadvantages.

This object is achieved by an accumulating device and a method for accumulating a stream of conveyed flat objects with the characteristics of the corresponding independent claims.

The accumulating or retaining device, thus, comprises a base of constant length, which is pressable against the stream by means of a pressing mechanism, with the pressing mechanism being designed for first pressing a first end of the base against the stream and then the rest of the base with a tilting movement towards the stream and, thus, by means of the tilting to form an accumulating region being enlarged in the direction opposed to the conveying direction.

This preferably relatively fast pressing of the first end or a head of the base and the preferably relatively slow tilting of the remaining region of the base against the scaled stream first effects a stopping of a first group of flat objects and then the forming of an accumulating region under the base being enlarged in a relatively continuous fashion in the direction opposed to the conveying direction.

In correspondence with the conveying speed, the accumulating region is formed slower or faster. This time must be sufficient for a sufficiently large gap to be formed in the scaled stream downstream of the accumulating region. Subsequently, the base is raised again and thus the accumulated section is released again and conveyed further. For raising the base the previous movements are reversed, i.e. the base is tilted back as well as the head raised again, preferably simultaneously.

At typical conveying rates of 40,000 to 80,000 objects per hour, this kind of accumulating cycle from the lowering of the head through to the raising of the device takes e.g. half a second to a full second. It may, however, also be longer at lower conveying speeds, i.e. take two or several seconds.

Preferably, stationary holding elements are provided. Hereby, the pressing mechanism (e.g. by means of downwards orientated protruding buffers) for clamping or pinching of flat objects is arranged in-between the pressing mechanism and the stationary holding elements. When pressing the first end of the base, the flat objects are pressed against the holding elements. The flat objects, thus, touch the holding elements directly, there is no conveying means, such as e.g. a conveying belt or a cable between the flat objects and the holding elements. Thus, the conveying means are prevented from rubbing against the flat objects under pressure.

Preferably, the base is elastic and resilient. This effects that corresponding to the resilience of the base and the force with which the flat objects are pressed against the base, an equilibrium is achieved, in which the objects are distributed at least approximately regularly under the base. Thus, the scaled stream also is approximately regularly compacted.

In a preferred embodiment of the invention, the base is formed by a belt, e.g. made of plastic or a textile material, of a blended material or it is formed by a band of metal, e.g. spring steel. The base may be smooth or equipped with a slip resistant coating and/or profiled or studded. The band is preferably tensed around individual elastic supports. These elastic supports couple the band to a rigid suspension, with the suspension, as a whole, being movable and pressable onto the scaled stream. However, a different arrangement of elastic elements, between suspension or arm and base, may be arranged e.g. with elements or bodies made of expanded material or rubber. Combinations are also possible e.g. the base consisting of a band of spring steel, which is suspended with an element of expanded material in relation to the suspension.

Preferably, in order to improve the homogenization of the accumulated scaled stream, a speed at which the tilting of the base takes place is adjusted according to the conveying speed of the scaled stream: the faster the scaled stream runs the faster the base must be tilted in order to achieve the same compacting. The speed is preferably also adjustable according to the thickness of the conveyed products. The speed may also be adjusted during the tilting, be it by means of an open loop controller, which determines the speed according to a predetermined course or a closed loop controller, which adapts the speed to e.g. the height of the scaled stream.

In a preferred embodiment of the invention, the base is arranged on an arm, wherein the arm is rotatable around an axis and the first end of the base is pressable against the stream by means of tilting the arm on the axis. The arm preferably protrudes from this axis freely and without further joints controlling the arm movement, and extends in an acute angle of preferably less than 30° or 20° in relation to the base. This means that the first end is not coupled to a further joint or moved or held by means of a further joint in the region of the first end. Arm and base are, thus, rotatable around a single common axis for the tilting movement. For the subsequent tilting of the base, i.e. the enlarging of the angle between arm and base, preferably a lowering mechanism is arranged for rotating the base around a point of rotation in the region of the first end of the base. Preferably, the lowering mechanism is also rotatable around the axis together with the arm, i.e. that e.g. a drive of the lowering mechanism is moved along with the arm.

In a mechanically differently designed preferable embodiment of the invention the first end and a second end of the base are movable by means of other mechanisms or drives, e.g. by vertically acting linear actuators for independent movement of the head of the base and a heel of the base.

What these different mechanical embodiments have in common is that the respective movements are substantially perpendicular to the conveying direction, wherein preferably the movements of the first end is a sudden, quick movement between two stopping positions, i.e. without a monitoring of the speed of the movement being necessary. This kind of movement may also e.g. be driven by a pneumatic, hydraulic or magnetic actuator. The movement of the heel or second end, i.e. the tilting of the base is on the other hand preferably controllable in its speed. Thus, a monitoring of the compacting of the conveyed objects is possible. For this purpose e.g. an electrical drive is suitable.

Preferably, the device comprises a presence detector, which captures whether one of the flat objects is under the first end of the base pressed against the stream. Thus, the pressing mechanism may only then tilt the rest of the base against the stream, when the presence detector shows the presence of a flat object under the first end of the base.

Further preferable embodiments emanate from the dependent claims.

### BRIEF DESCRIPTION OF THE DRAWINGS

In the following the object of the invention is explained in more detail on the basis of preferred embodiment examples, which are shown in the enclosed drawings.

FIGS. 1 to 3 each diagrammatically show an accumulating device in a different condition.

The reference numerals in the drawings and their denotations are summarized in the reference numeral list. In the figures identical parts are basically denotated with identical reference numerals.

### DETAILED DESCRIPTION OF THE INVENTION

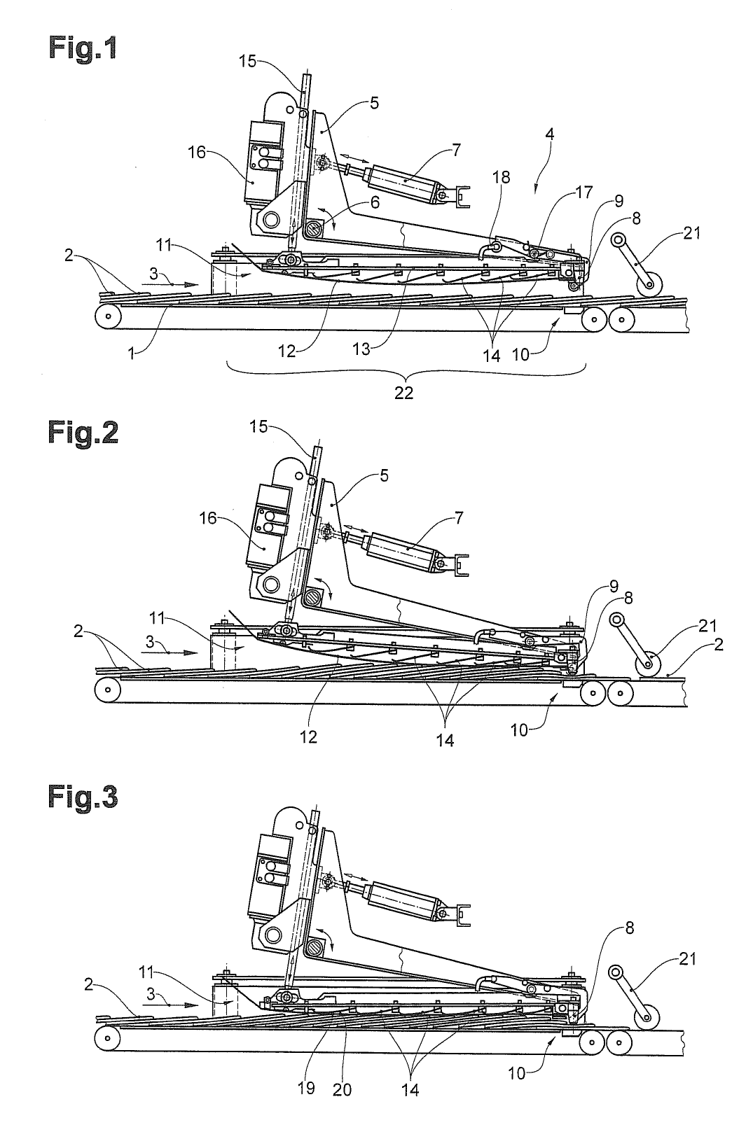

FIGS. 1 to 3 show the accumulating device 4 in different conditions of an accumulating cycle. The accumulating device 4 is arranged above a conveying belt 1 with a scaled stream of flat objects 2 conveyed on it. In the shown example, the downstream edges of the flat objects 2 are shown as lying on top, they may however lie on the bottom side of the scaled stream. The scaled stream is conveyed in a conveying direction 3 towards the accumulating device 4. The accumulating device 4 comprises a pressing mechanism with an arm 5 rotatable around an axis 6, which extends approximately horizontally in conveying direction 3. The rotation of the arm 5 around the axis 6 is controlled by an arm drive 7. On an outer first end of arm 5 distant to axis 6 buffers 8 orientated downwards and a mechanical probe 9 are arranged. The mechanical probe 9 is movable around a probe axis 17, wherein a second end of the mechanical probe 9 lies in the capturing range of a probe sensor 18 and thus the probe sensor 18 generates a signal according to the required position of the mechanical probe 9.

At the end of arm 5, an optional pressing roller may be attached, which lies on the flat objects 2 and presses these towards the conveying belt 1. The drive roller 21 may be freewheeling or driven.

Along an underside of the arm 5, facing the conveying belt 1 with the scaled stream, a base 12 of the pressing mechanism is arranged. The base 12 is as a whole rotatable around a rotation point in the region of the outer end of arm 5, corresponding to a head 10 of the base 12. This rotation is controlled by a lowering mechanism 15 arranged at the other end of the base 12, also called heel 11, which mechanism is again driven by a lowering drive 16. With the lowering drive 16, thus, an angle between arm 5 and base 12 is adjustable. The lowering drive 16 is preferably attached to arm 5 and moves with it. It can, however, also be arranged on a stationary part and only be connected via the lowering mechanism 15 with the arm or the heel 11 respectively.

The base 12 is preferably resilient, in particular elastically suspended to a rigid carrier 13 moved by the lowering mechanism 15. This suspension is, in the shown preferred embodiment implemented by a plurality of supporting elements 14. Preferably, these supporting elements 14 are bands or spiral springs made of spring steel, which are clamped on the carrier and the base 12 is formed of a smooth or coated spring steel band or of a different band material. The base 12 is preferably tensed over the ends of the supporting elements 14 and for this purpose must not be fastened on these ends. Thus by means of the pressing mechanism the area of the base 12 is pressable against the stream of flat objects 2 and spring-loaded.

Preferably, the areas of the carriers 13 each run from the supporting element 14 against the conveying direction 3 to base 12. Thus an advantageous adaptability of the elastic base 12 to the upper side of the accumulated scaled stream and an at least partial homogenization of the accumulated scaled stream is provided. FIG. 3 shows corresponding elevations 20 in the base 12, which are formed by the pressure of the flat objects 2 against the base 12 and cavities 19 in the region of the supporting elements 14.

The individual steps of an accumulating cycle are apparent from the succession of the FIGS. 1 to 3: FIG. 1 shows the starting condition for normal operation of the conveying device. For short term accumulating of the scaled stream, the arm 5 is rotated by the arm drive 7 and thus the outer end of the arm 5 and with it the head 10 of the base 12 is moved towards the scaled stream. The head 10 and buffers 8 attached to it are pressed against the scaled stream and holding elements 23 arranged below the scaled stream. Thus one or several flat objects are held by means of clamping or pinching between the buffers 8 and the holding elements 23 (FIG. 2). Individual flat objects 2 lying under the buffers 8, but not being in direct contact with these are pressed against conveying belt 1 by means of the optional pressing roller 21. Because of this, these flat objects 2 are conveyed further by the conveying belt 1 against the breaking force of the buffers 8 and drawn out from under the buffers 8 and the flat objects 2 lying directly on the buffers 8.

Now the following flat objects 2 start being accumulated at the accumulating point and an accumulating region 22 is formed. With the mechanical probe 9, the device detects that a scaled stream is in fact lying under head 10, by which the lowering of the heel 11 by means of the lowering mechanism 15 is activated. Thus, the base 12 also tilts with the remaining region as a whole, this against the conveying direction 3. The faster the flat objects 2 are transported, the faster the heel 11 must be lowered in order to achieve the same degree of compacting of the scaled stream. If the flat objects 2 are thin, the lowering may happen slower than with thicker objects. FIG. 3 shows the situation with a completely lowered heel 11 and with accumulated objects 2 lying close to one another in the entire accumulating region 22. Corresponding to the conveying rate, this condition may be reached in less than a second after the lowering of the head 10. Depending on the size of the required gaps to be formed in the scaled stream, the accumulating cycle may be shorter or longer. Corresponding to this requirement, the length of the base 12 or the accumulating device 4 may also be adapted.

For termination of the accumulating, the arm drive 7 rotates the arm back into the starting position according to FIG. 1 and the lowering drive 16 lifts the heel 11 again, with the base 12 releasing the accumulated scaled stream again.

### REFERENCE NUMERALS

1 conveying belt
2 flat object
3 conveying direction
4 accumulating direction
5 arm
6 axis
7 arm drive
8 buffer
9 mechanical probe
10 head
11 heel
12 base
13 carrier
14 supporting element
15 lowering mechanism
16 lowering drive
17 probe axis
18 probe sensor
19 cavity
20 elevation
21 pressing roller
22 accumulating region
23 holding element

1. An accumulating device (4) for accumulating a stream of flat objects (2) conveyed in a conveying direction (3) in an accumulating region (22) of the stream, wherein the accumulating device (4) comprises:
a base (12) of constant length, which base (12) is pressable against the stream by means of a pressing mechanism (5, 7, 8, 9, 13, 14, 15, 16), and
wherein the pressing mechanism (5, 7, 8, 9, 13, 14, 15, 16) is arranged for first pressing a first end (10) of the base (12) against the stream and then the rest of the base (12) with a tilting movement towards the stream and, thus by means of the tilting, forming an accumulating region (22) being enlarged in the direction opposed to the conveying direction (3).

2. The accumulating device (4) according to claim 1, further comprising stationary holding elements (23) arranged below the stream, wherein the pressing mechanism (5, 7, 8, 9, 13, 14, 15, 16) is configured for the clamping of flat objects (2) between the pressing mechanism and the stationary holding elements (23).

3. The accumulating device (4) according to claim 1, wherein on the first end (10) of the base (12) buffers (8) orientated downwards for clamping of flat objects (2) between the pressing mechanism and the stationary holding elements (23) are arranged.

4. The accumulating device (4) according to claim 1, wherein the base (12) is elastic and resilient.

5. The accumulating device (4) according to claim 4, wherein the base (12) is formed of a spring steel band (12) and the area of the spring steel band is pressable by means of the pressing mechanism (5, 7, 8, 9, 13, 14, 15, 16) onto the stream of flat objects (2).

6. The accumulating device (4) according to claim 1, wherein the base (12) by means of elastic supporting elements (14) is fixed to a rigid carrier (13) and the pressing mechanism (5, 7, 8, 9, 13, 14, 15, 16) drives the carrier (13).

7. The accumulating device (4) according to claim 6, wherein the supporting elements (14) are formed of spring steel.

8. The accumulating device (4) according to claim 6, wherein the areas of the supporting elements (14) run from the carrier against the conveying direction (3) to the base (12).

9. The accumulating device (4) according to claim 1, wherein the base (12) is arranged on an arm (5), wherein the arm (5) together with the base (12) is rotatable around an axis (6) and the first end (10) of the base (12) is pressable against the stream by tilting the arm (5) around the axis (6), wherein the axis (6) is in the region of the second end (11) of the base.

10. The accumulating device (4) according to claim 1, comprising a lowering mechanism (15) for tilting the base (12) around a rotation point in the region of the first end (10) of the base (12).

11. The accumulating device (4) according to claim 10, wherein the lowering mechanism (15) is driven by means of a drive (16) moved along with the arm (5).

12. The accumulating device (4) according to claim 1, further comprising a presence detector (9, 18) for determining whether one of the flat objects (2) is located under the first end (10) of the base (10) pressed towards the stream.

13. The accumulating device (4) according to claim 12, wherein the pressing mechanism (5, 7, 8, 9, 13, 14, 15, 16) is arranged for only tilting the rest of the base (12) towards the stream when the means for presence capturing (9, 18) registers the presence of a flat object (2) under the first end (10) of the base.

14. The accumulating device (4) according to claim 1, wherein a first drive (7), which presses the first end (10) of the base (12) against the stream is de-signed for a fast movement without controlling the speed of the movement.

15. The accumulating device (4) according to claim 1, wherein a second drive (16), which tilts the remaining region of the base (12) towards the stream is designed for a movement with a controlled speed.

16. The accumulating device (4) according to claim 15, wherein a control of the second drive (16) is set up for controlling the speed of the movement in dependence of a conveying speed of the stream.

17. A method for accumulating a stream of flat objects (2) conveyed in a conveying direction (3) in an accumulating region (22) of the stream, wherein the method comprises the following steps, in the following order:
pressing of a first end (10) of a base (12) of a pressing mechanism (5, 7, 8, 9, 13, 14, 15, 16) against the stream; and
tilting of a remaining region of the base (12) against the stream and thus forming a accumulating region (22) being enlarged in the direction opposing the conveying direction (3).

18. The method according to claim 17, wherein when pressing on the first end (10) of the base (12) the flat objects (2) are pressed directly towards stationary holding elements (23) arranged below the stream.

19. The method according to claim 17, comprising, after pressing on of the first end (10), the step:
detecting whether one of the flat objects is present under the first end (10) of the base (12), which is pressed against the stream;
and where the tilting of the remaining region of the base (12) against the stream is only then activated, when this detecting shows the presence of a flat object (2) under the first end (10) of the base (12).
